(19) United States
(12) Patent Application Publication
(10) Pub. No.: US 2024/0146506 A1
(43) Pub. Date: May 2, 2024

(54) SIMULATING CIPHERTEXTS USING SMALLER CIPHERTEXTS PACKED WITH DESIGNATED PACKING

(71) Applicant: International Business Machines Corporation, Armonk, NY (US)

(72) Inventors: Ehud AHARONI, Kfar Saba (IL); Nir DRUCKER, Zichron Yaakov (IL); Hayim SHAUL, Kfar Saba (IL)

(21) Appl. No.: 18/051,734

(22) Filed: Nov. 1, 2022

(51) Int. Cl. H04L 9/06

(52) U.S. Cl. CPC H04L 9/0637

(57) ABSTRACT

An example system includes a processor to pack a received tensor using a designated packing to generate a number of smaller ciphertexts. The processor can compute a rotation using the number of smaller ciphertexts to simulate a rotation operation on the tensor.

### BACKGROUND

The present techniques relate to ciphertext operations. More specifically, the techniques relate to simulating ciphertexts.

Fully homomorphic encryption (FHE) schemes allow computing functions on encrypted data. For example, FHE schemes use the primitive operations add, multiply, and rotate elementwise on ciphertexts, where each ciphertext encrypts a vector of some given length, and the add and multiply operations are performed elementwise. In various examples, the rotate operation may move one or more elements of a ciphertext to the left or right a number of indicated offset.

Many FHE algorithms assume a minimum number of slots in a ciphertext that depends on the size of the input. These algorithms require more slots as the input grows. Currently FHE implementations may also have a cap on the number of slots supported. Also, increasing the number of slots comes with an efficiency cost. As a result, these algorithms may not work on inputs larger than some limit.

Some methods exist for efficiently utilizing these low-level FHE scheme primitive operators for performing higher-level operators such as convolution and matrix-multiplication. However, these methods may assume that an input tensor fits within a single ciphertext. A tensor, as used herein, refers to an array of values. For example, the tensor may be a vector, a matrix, or some other multi-dimensional array of values. For example, if the convolution is performed on an image of size 256×256, then the ciphertext may be expected to be able to contain 64,000 slots. Such an assumption may be used for a convolutional algorithm that may assume that a flattened image fits within a ciphertext, or a multi-channel convolution that assumes that at least one channel of an image fits within a ciphertext. Another example may be a matrix-vector multiplication with diagonalization that assumes that a vector fits within a ciphertext. However, fitting an image or vector into a ciphertext may not always be feasible. For example, some common FHE implementations, may only allow ciphertexts having up to 16,000 slots. Also, working with large ciphertexts may not always be efficient, as the operation cost may be more than linear in the size of the ciphertext. Therefore, working with the ciphertext of a large size can be costly. In particular, processing time may increase according to the function O(n log n), where n is the ciphertext degree. This may be the case, for example, with the use of algorithms such as Number Theoretic Transform (NTT) or Fast Fourier Transform (FFT) algorithms.

### SUMMARY

According to an embodiment described herein, a system can include processor to pack a received tensor using a designated packing to generate a number of smaller ciphertexts. The processor can also further compute a rotation using the number of smaller ciphertexts to simulate a rotation operation on the tensor. Thus, the system provides efficient simulation of rotation operations on tensors. In some embodiments, the processor is to store a smaller ciphertext rotation in a rotation cache and use the stored rotation from the rotation cache for an additional offset on the received tensor instead of executing an additional rotation. In these embodiments, the system provides additional efficiency when processing rotation operations. In some embodiments, computing the rotation includes moving a smaller ciphertext and rotating the moved ciphertext. In these embodiments, the system provides efficient simulation of rotation operations on tensors by manipulation of smaller ciphertexts. In some embodiments, the processor can use the simulated rotation to simulate a rotation operation in an algorithm with a tile size constraint or ciphertext size constraint to remove the tile size constraint or ciphertext size constraint. In these embodiments, the system enables processing of input without any size constraints. In some embodiments, process rotations on the smaller ciphertexts in parallel. In these embodiments, the system provides additional efficiency in processing rotations.

According to another embodiment described herein, a computer-implemented method can include packing, via a processor, a received tensor using a designated packing to generate a number of smaller ciphertexts. The method can further include computing, via the processor, a rotation using the number of smaller ciphertexts to simulate a rotation operation on the tensor. Thus, the method provides efficient simulation of rotation operations on tensors. In some embodiments, the method can also further include storing, via the processor, a smaller ciphertext rotation in a rotation cache and using the stored rotation from the rotation cache for an additional offset on the received tensor instead of executing an additional rotation. In these embodiments, the method provides additional efficiency when processing rotation operations. In some embodiments, computing the rotation includes moving a smaller ciphertext and rotating the moved ciphertext. In these embodiments, the method provides efficient simulation of rotation operations on tensors by manipulation of smaller ciphertexts. In some embodiments, the method can also further include simulating, via the processor, the rotation operation in an algorithm with a tile size constraint to remove the tile size constraint. In these embodiments, the method enables processing of input without any size constraints. In some embodiments, the method can also further include processing, via the processor, rotations on the smaller ciphertexts in parallel. In these embodiments, the method provides additional efficiency in processing rotations.

According to another embodiment described herein, a computer program product for simulating rotation operations can include computer-readable storage medium having program code embodied therewith. The program code executable by a processor to cause the processor to pack a received tensor using an interleaved packing to generate a number of smaller ciphertexts. The program code can also cause the processor to compute a rotation using the number of smaller ciphertexts to simulate a rotation operation on the tensor. Thus, the computer program product can provide efficient simulation of rotation operations on tensors. In some embodiments, the program code can also cause the processor to store a smaller ciphertext rotation in a rotation cache and use the stored rotation from the rotation cache for an additional offset on the received tensor instead of executing an additional rotation. In these embodiments, the computer program product provides additional efficiency when processing rotation operations. In some embodiments, the program code can also cause the processor to move a smaller ciphertext relative to another smaller ciphertext and rotate the moved ciphertext. In these embodiments, the computer program product provides efficient simulation of rotation operations on tensors by manipulation of smaller ciphertexts. In some embodiments, the program code can also cause the processor to simulate the rotation operation in an algorithm with a tile size constraint to remove the tile size constraint. In these embodiments, the computer program product enables processing of input without any size constraints. In some embodiments, the program code can also cause the processor to also further process rotations on the smaller ciphertexts in parallel. In these embodiments, the computer program product provides additional efficiency in processing rotations.

According to an embodiment described herein, a system can include processor to pack a received multi-dimensional tensor using a designated packing to generate a number of smaller multi-dimensional tiles. The processor can also further compute a rotation using the number of smaller multi-dimensional tiles to simulate a rotation operation on the multi-dimensional tensor along a dimension. Thus, the system provides efficient simulation of rotation operations on multi-dimensional tensors. In some embodiments, the processor is to store a smaller multi-dimensional tile rotation in a rotation cache and use the stored rotation from the rotation cache for an additional offset on the received multi-dimensional tensor instead of executing an additional rotation. In these embodiments, the system provides additional efficiency when processing rotation operations on multi-dimensional tensors. In some embodiments, the processor can move a row of smaller multi-dimensional tiles relative to other rows of smaller multi-dimensional tiles, and rotate the moved row of smaller multi-dimensional tiles. In these embodiments, the system provides efficient simulation of rotation operations on tensors by manipulation of smaller multi-dimensional tiles. In some embodiments, the processor can use the simulated rotation to simulate a rotation operation in an algorithm with a tile size constraint to remove the tile size constraint. In these embodiments, the system enables processing of input without any size constraints. In some embodiments, process rotations on the smaller multi-dimensional tiles in parallel. In these embodiments, the system provides additional efficiency in processing rotations.

According to another embodiment described herein, a computer-implemented method can include packing, via a processor, a received multi-dimensional tensor using a designated packing to generate a number of smaller multi-dimensional tiles. The method can further include computing, via the processor, a rotation using the number of smaller multi-dimensional tiles to simulate a rotation operation on the multi-dimensional tensor. Thus, the method provides efficient simulation of rotation operations on multi-dimensional tensors. In some embodiments, the method can also further include storing, via the processor, a smaller multi-dimensional tile rotation in a rotation cache and using the stored rotation from the rotation cache for an additional offset on the received multi-dimensional tensor instead of executing an additional rotation. In these embodiments, the method provides additional efficiency when processing rotation operations. In some embodiments, computing the rotation includes moving a smaller multi-dimensional tile and rotating the moved multi-dimensional tile. In these embodiments, the method provides efficient simulation of rotation operations on tensors by manipulation of smaller multi-dimensional tiles. In some embodiments, the method can also further include simulating, via the processor, the rotation operation in an algorithm with a tile size constraint to remove the tile size constraint. In these embodiments, the method enables processing of input without any size constraints. In some embodiments, the method can also further include processing, via the processor, rotations on the smaller multi-dimensional tiles in parallel. In these embodiments, the method provides additional efficiency in processing rotations.

### BRIEF DESCRIPTION OF THE SEVERAL VIEWS OF THE DRAWINGS

FIG. 1 is a block diagram of an example computing environment that contains an example of an environment for the execution of at least some of the computer code involved in performing the inventive methods, such as ciphertext simulation and tensor rotation;

FIG. 2 is an example tangible, non-transitory computer-readable medium that can simulate rotations of tensors using smaller ciphertexts generated using a designated packing;

FIG. 3 is a process flow diagram of an example method that can simulate rotations of tensors using smaller ciphertexts generated using a designated packing;

FIG. 4 is a process flow diagram of an example method that can simulate rotations of multi-dimensional tensors using smaller tiles generated using a designated packing;

FIG. 5 is a block diagram shows an example interleaved packing for generating smaller ciphertexts that can be used to simulate rotation of larger ciphertexts;

FIG. 6 is a block diagram shows an example simulated rotation of a tensor using smaller ciphertexts;

FIG. 7 is a block diagram shows an example simulated rotation of a tensor with an offset of two using smaller ciphertexts; and

FIG. 8 a block diagram of a simulated rotation of a multi-dimensional tensor using smaller tiles.

### DETAILED DESCRIPTION

A naive approach to address the problem of large ciphertexts may be to divide a large ciphertext into n contiguous blocks and store each one in a small ciphertext. Applying multiply and add operations is done by applying them pairwise on each smaller ciphertext. Applying a rotate operation would thus require rotating each of the smaller ciphertexts, and then multiplying by masks to move one element from each smaller ciphertext to the next. A rotation operation in this example may thus cost n rotations, n multiplications by masks, and +1 multiplication depth. Thus, such approach may still be very inefficient. Moreover, some systems may have a limit on multiplication depth, which is the number of times in which multiplication operations are performed one after the other. In other systems increasing the multiplication depth may lead to an increased number of costly bootstrapping operations.

According to embodiments of the present disclosure, a method to efficiently simulate large ciphertexts using smaller ciphertexts is disclosed. For example, the embodiments can convert a computation that uses homomorphic encryption assuming ciphertexts of a certain size, to a computation that runs on smaller ciphertexts. In some examples, the embodiments can include packing each large ciphertext into the smaller ciphertexts using a designated packing, which enables efficiently simulation of each operation on the large ciphertext using not more than one operation on each small ciphertext, and on average much less. As used herein, packing refers to a technique that takes data and arranges the data inside of a ciphertext. An additional rotation cache reduces the number of rotation operations performed even further, by re-using the same rotated small ciphertexts to simulate multiple different rotation offsets of a large ciphertext. An example system includes a processor to pack a received tensor using a designated packing to generate a number of smaller ciphertexts. The processor can compute a rotation using the number of smaller ciphertexts to simulate a rotation operation on the tensor. Thus, embodiments of the present disclosure enable the conversion of any algorithm that assumes the input tensor fits within a single ciphertext to an algorithm that has no such size constraint, and without any performance cost. The embodiments described herein also improve the time performance of any algorithm that assumes the input tensor fits into a single ciphertext by dividing it into smaller tiles, as much as security constraints allow. Tiles, as used herein, refer to ciphertexts whose content combine together to form some larger data object. For example, tiles can hold a tensor, where each tile contains a small piece of this tensor. Another example, tiles can together form the context of a larger ciphertext. In particular, the processing time for increasingly larger vectors may increase according to the function O(n). This time performance improvement is due to the processor performing less than n rotations on the smaller tiles because of both the packing and rotation method, as well as the rotation cache. In addition, since ciphertext operations have an above-linear complexity, dividing the addition, multiplication, and rotation operators to n smaller tiles improves their performance. Finally, the resulting smaller tasks may be easier to parallelize. Furthermore, the embodiments described herein are applicable to any HE algorithm and any existing packing technique. For example, given an HE algorithm that manipulates ciphertexts containing data packed in some given way, then the processor can break each input ciphertext into smaller ones using a designated packing method, such as the interleaved packing method described herein. The processor can then run the HE algorithm by converting each operation on a large ciphertext to operations on the smaller ones. For example, add and multiply are directly converted pairwise on the smaller ciphertexts. Rotations may also be converted using embodiments described herein. Moreover, the embodiments herein are compatible with any other packing techniques, which may be used to pack a vector or tensor that is then broken down into smaller ciphertexts or tiles using the embodiments described herein. Finally, some of the embodiments enable increasing power of a tile tensor framework layer by supporting n-dimensional efficient rotations.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as ciphertext and tensor rotator module 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

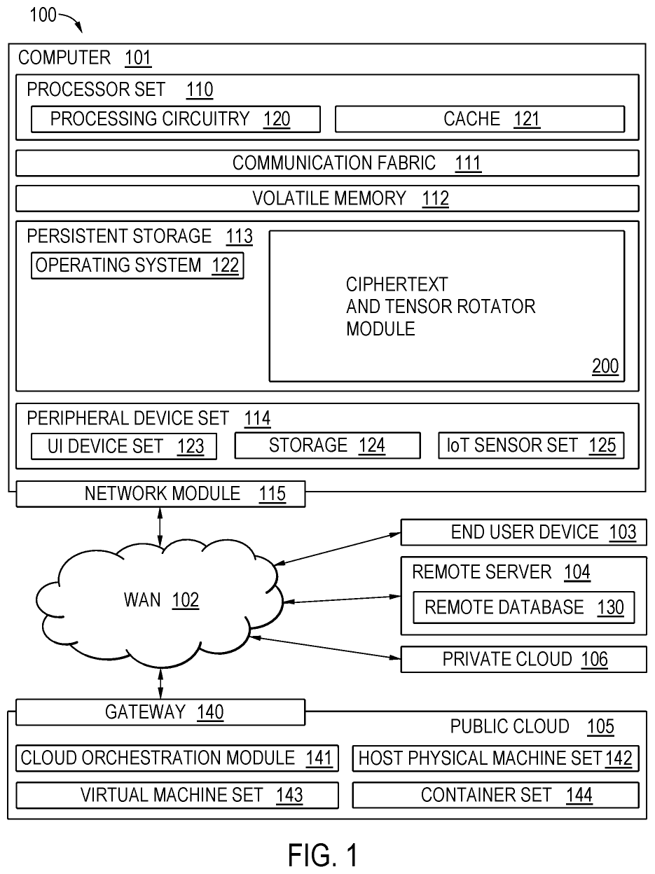

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

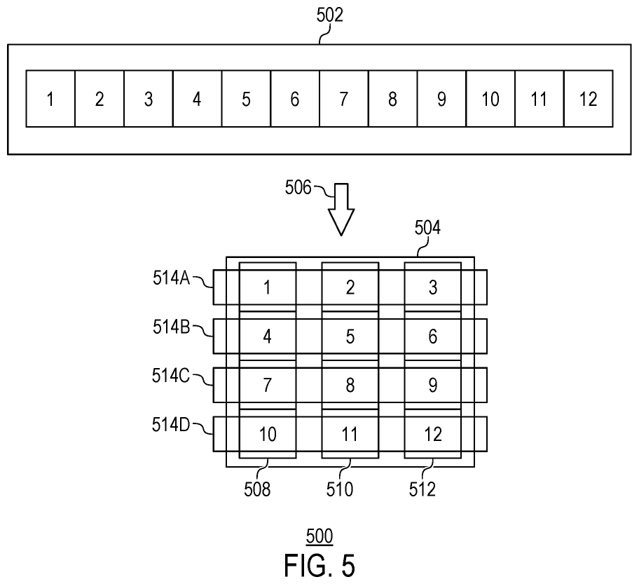

In various examples, the ciphertext and tensor rotator module 200 can cause the processor set 110 to pack a received tensor using a designated packing to generate a number of smaller ciphertexts. For example, the designated packing may be the interleaved packing described in detail in FIG. 5. In some examples, the ciphertext and tensor rotator module 200 can cause the processor set 110 to pack a received multi-dimensional tensor using a designated packing to generate a number of smaller multi-dimensional tiles. The ciphertext and tensor rotator module 200 can cause the processor set 110 to compute a rotation using the number of smaller ciphertexts to simulate a rotation operation on the tensor. The ciphertext and tensor rotator module 200 can cause the processor set 110 to move a smaller ciphertext and rotate the moved ciphertext. In some examples, the ciphertext and tensor rotator module 200 can cause the processor set 110 to move a row of smaller multi-dimensional tiles relative to other rows of smaller multi-dimensional tiles, and rotate the moved row of smaller multi-dimensional tiles. In various examples, the ciphertext and tensor rotator module 200 can cause the processor set 110 to process rotations on the smaller ciphertexts in parallel. In some examples, the ciphertext and tensor rotator module 200 can cause the processor set 110 to compute a rotation using the number of smaller multi-dimensional tiles to simulate a rotation operation on the multi-dimensional tensor along a dimension. The ciphertext and tensor rotator module 200 can cause the processor set 110 to store a smaller ciphertext rotation in a rotation cache. The ciphertext and tensor rotator module 200 can cause the processor set 110 to use the stored rotation from the rotation cache for an additional offset on the received tensor instead of the rotator sub-module 208 executing an additional rotation. In some examples, the ciphertext and tensor rotator module 200 can cause the processor set 110 to store a smaller multi-dimensional tile rotation in a rotation cache and use the stored rotation from the rotation cache for an additional offset on the received tensor instead of executing an additional rotation. The ciphertext and tensor rotator module 200 can cause the processor set 110 to use the simulated rotation to simulate a rotation operation in an algorithm with a tile size constraint or ciphertext size constraint to remove the tile size constraint or ciphertext size constraint.

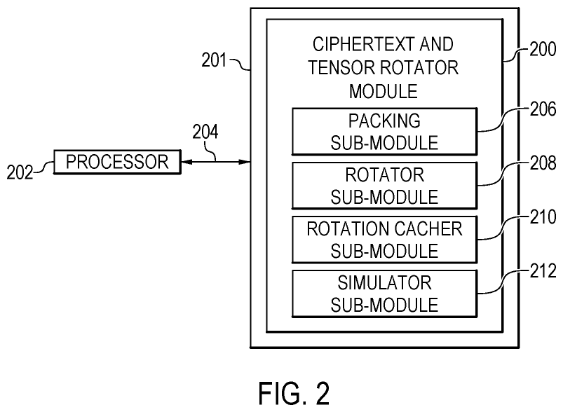

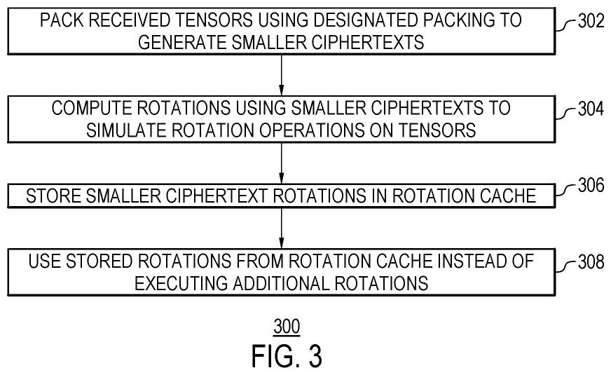

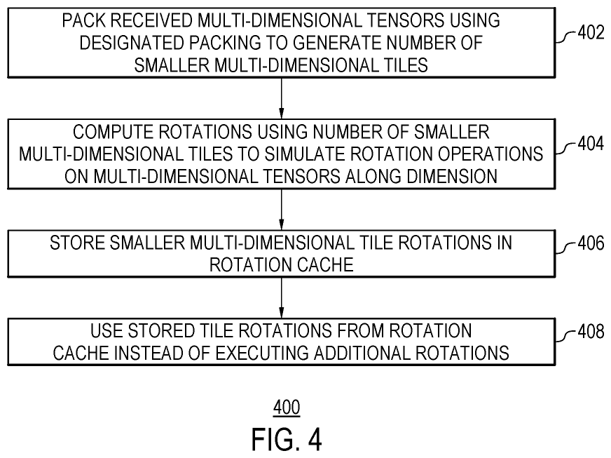

Referring now to FIG. 2, a block diagram is depicted of an example tangible, non-transitory computer-readable medium 201 that can simulate rotations of tensors using smaller ciphertexts generated using a designated packing. The tangible, non-transitory, computer-readable medium 201 may be accessed by a processor 202 over a computer interconnect 204. Furthermore, the tangible, non-transitory, computer-readable medium 201 may include code to direct the processor 202 to perform the operations of the method 300 of FIG. 3 or the method 400 of FIG. 4.

The various software components discussed herein may be stored on the tangible, non-transitory, computer-readable medium 201, as indicated in FIG. 2. For example, the ciphertext and tensor rotator module 200 may include a packing sub-module 206 includes code to pack a received tensor using a designated packing to generate a number of smaller ciphertexts. For example, the designated packing may be the interleaved packing of FIG. 5. In some examples, the packing sub-module 206 includes code to pack a received multi-dimensional tensor using a designated packing to generate a number of smaller multi-dimensional tiles. The ciphertext and tensor rotator module 200 may include a rotator sub-module 208 that includes code to compute a rotation using the number of smaller ciphertexts to simulate a rotation operation on the tensor. The rotator sub-module 208 further includes code to move a smaller ciphertext and rotate the moved ciphertext. In some examples, the rotator sub-module 208 further includes code to move a row of smaller multi-dimensional tiles relative to other rows of smaller multi-dimensional tiles, and rotate the moved row of smaller multi-dimensional tiles. In various examples, the rotator sub-module 208 also includes code to process rotations on the smaller ciphertexts in parallel. In some examples, the rotator sub-module 208 also includes code to compute a rotation using the number of smaller multi-dimensional tiles to simulate a rotation operation on the multi-dimensional tensor along a dimension. The ciphertext and tensor rotator module 200 may further include a rotation cacher sub-module 210 that includes code to store a smaller ciphertext rotation in a rotation cache. The rotation cacher sub-module 210 also includes code to use the stored rotation from the rotation cache for an additional offset on the received tensor instead of the rotator sub-module 208 executing an additional rotation. In some examples, the rotation cacher sub-module 210 may include code to store a smaller multi-dimensional tile rotation in a rotation cache and use the stored rotation from the rotation cache for an additional offset on the received tensor instead of executing an additional rotation. The ciphertext and tensor rotator module 200 may include a simulator sub-module 212 that includes code to use the simulated rotation to simulate a rotation operation in an algorithm with a tile size constraint or ciphertext size constraint to remove the tile size constraint or ciphertext size constraint.

FIG. 3 is a process flow diagram of an example method that can simulate rotations of tensors using smaller ciphertexts generated using a designated packing. The method 300 can be implemented with any suitable computing device, such as the computer 101 of FIG. 1. For example, the methods described below can be implemented by the processor set 110 of FIG. 1.

At block 302, a processor packs received tensors using a designated packing to generate a number of smaller ciphertexts. For example, the tensors may correspond to larger ciphertexts, which may have been packed using any suitable packing method. In various examples, the tensors may be vectors, matrices, or higher-dimensional arrays of values. In some examples, the values may be encrypted. In various examples, the designated packing may be an interleaved packing, such as the interleaved packing method described in FIG. 5. For example, when packing a vector v=[v₀, v₁, . . . , vₖ₋₁] into n=ceil(k/s) smaller tiles T₀, T₁, . . . , Tₙ₋₁ of size s each: Element vᵢ is placed in tile number i % n, at slot floor(i/n). In FIG. 5, this interleaved packing is demonstrated with values of k=12, and n=4. In various examples, this interleaved packing can be generalized to a tensor T of shape [n₁, n₂, . . . , nₖ], that is packed into smaller tiles such that each tile is capable of holding a subset tensor of size [t₁, t₂, . . . , tₖ]. The required tiles may form an array of size [e₁, e₂, . . . , eₖ] where eᵢ=ceil(nᵢ/tᵢ). The element of T at (i₁, i₂, . . . , iₖ) is placed at the tile which is at position (i₁% e₁,i₂% e₂, . . . , iₖ % eₖ) in the array of tiles, and inside the tile at position (floor(i₁/e₁), floor(i₂/e₂), . . . floor(iₖ/eₖ)).

At block 304, the processor computes rotations using the number of smaller ciphertexts to simulate rotation operations on the tensors. For example, the processor can move a smaller ciphertext and rotate the moved ciphertext. In various examples, the processor can process rotations on the smaller ciphertexts in parallel.

At block 306, the processor stores smaller ciphertext rotations in a rotation cache. For example, the rotation cache may be a portion of memory dedicated to storing ciphertext rotations.

At block 308, the processor uses the stored rotation from the rotation cache for an additional offset on the received tensor instead of executing additional rotations. For example, a rotation with an offset of two may only calculate one rotation and use one stored rotation. In various examples, any number of stored rotations may be used for larger offsets.

The process flow diagram of FIG. 3 is not intended to indicate that the operations of the method 300 are to be executed in any particular order, or that all of the operations of the method 300 are to be included in every case. Additionally, the method 300 can include any suitable number of additional operations. For example, the method 300 may include using the simulated rotation to simulate a rotation operation in an algorithm with a tile size constraint or ciphertext size constraint to remove the tile size constraint or ciphertext size constraint.

FIG. 4 is a process flow diagram of an example method that can simulate rotations of multi-dimensional tensors using smaller tiles generated using a designated packing. The method 400 can be implemented with any suitable computing device, such as the computer 101 of FIG. 1. For example, the methods described below can be implemented by the processor set 110 of FIG. 1.

At block 402, a processor packs received multi-dimensional tensors using a designated packing to generate a number of smaller multi-dimensional tiles. For example, the tensors may be encrypted. In various examples, the designated packing may be the interleaved packing method described in FIG. 5.

At block 404, the processor computes rotations using the number of smaller multi-dimensional tiles to simulate rotation operations on the multi-dimensional tensor along a dimension. For example, the processor can move a row of smaller multi-dimensional tiles relative to other rows of smaller multi-dimensional tiles, and rotate the moved row of smaller multi-dimensional tiles. In various examples, the smaller multi-dimensional tiles may themselves be arranged in a multi-dimensional array. Thus, the movement may effectively be a rotation of this array over the same dimension. In various examples, the processor can process rotations on the smaller multi-dimensional tiles in parallel.

At block 406, the processor stores smaller multi-dimensional tile rotations in a rotation cache. For example, the rotation cache may be a portion of memory dedicated to storing multi-dimensional tile rotations.

At block 408, the processor uses the stored rotations from the rotation cache for additional offsets on the received tensor instead of executing additional rotations. For example, the processor may use one or more tile rotations when processing the same tiles with high numbers of offsets.

The process flow diagram of FIG. 4 is not intended to indicate that the operations of the method 400 are to be executed in any particular order, or that all of the operations of the method 400 are to be included in every case. Additionally, the method 400 can include any suitable number of additional operations. For example, the method 400 may include using the simulated rotation to convert an algorithm with a tile size constraint or ciphertext size constraint into an algorithm without any tile size constraint or ciphertext size constraint.

With reference now to FIG. 5, a block diagram shows an example interleaved packing for generating smaller ciphertexts that can be used to simulate rotation of larger ciphertexts. The example interleaved packing 500 of FIG. 5 includes a received vector 502 of values. For example, the vector 502 may be a ciphertext that includes 12 elements in a single row. The interleaved packing 500 includes a set 504 of smaller ciphertexts generated from the vector 502, as shown by an arrow 506. The set 504 includes smaller ciphertexts 508, 510, and 512. Each of the smaller ciphertexts 508, 510, and 512 are shown arranged vertically and include a first slot 514A, a second slot 514B, a third slot 514C, and a fourth slot 514D.

In the example of FIG. 5, an interleaved packing 500 may be used to pack the content of a large vector 502 into n smaller ciphertexts. For example, the vector 502 may be in the form. v=[v₀, v₁, . . . , vₖ₋₁]. In the example of FIG. 5, v[0]=1, v[1]=2, v[2]=3, v[5]=6.

In various examples, the number of ciphertexts may be calculated using the equation:

n=ceil(k/s) Eq. 1

where k is the number of elements in the vector 502, s is the number of slots in each ciphertext, and ceil(x) is a function that computes a smallest integer that is greater than or equal to x. In the example of FIG. 5, the number of vector elements k=12, the number of slots in smaller ciphertexts s=4, and the number of ciphertexts n=3. The associated tile number t, or ciphertext number, of a particular value index i may be calculated using the equation:

t=i% n Eq. 2

The slot number Sn for a particular value index i can be calculated using the equation:

Snᵢ=floor(i/n) Eq. 3

where floor(x) is a function that returns the largest integer value that is less than or equal to a number x. As one example, for a given element of vector 502 i=5, the tile number or ciphertext number may be calculated as 5%3=2 and the slot number may be calculated using floor(5/3)=1. The original data of vector 502 is then readable row by row, or slot by slot, across the smaller ciphertexts 508, 510, and 512. For example, slot 0 of each of the smaller ciphertexts 508, 510, and 512 may be read first, then slot 1, slot 2, etc., up to slot n.

Thus, a processor can pack a vector 502 v=[v₀, v₁, . . . , vₖ₋₁] into n=ceil(k/s) smaller tiles T₀, T₁, . . . , Tₙ₋₁ of size s each. Element vᵢ is placed in tile number i % n, at slot floor(i/n). Given a left-rotation of v by offset j rot(v,j), and vector T of tiles [T0, T1, . . . , Tn−1], then v can be rotated in the packed form as follows. First, the processor can perform rot(T,j). The resulting tiles after this rotation may be denoted as T0′, T1′, . . . Tn−1′. Subsequently, the processor can rotate every Ti′ by rot(Ti′,floor((i+j)/n)). For example, rot(v,1) results with this array of tiles: T1, T2, . . . , Tn−1, rot(T0,1). Similarly, rot(v,2) results with this array of tiles: T2, . . . , Tn−1, rot(T0,1), rot(T1,1). As another example, rot(v,−1) results with this array of tiles: rot(Tn−1,−1), T0, T1, T2, . . . , Tn−2. In various examples, as can be seen, rot(v,2) and rot(v,1) both re-use rot(T0,1). Thus, in some examples, the processor may use a rotation cache, to store all rotated versions of each tile. Therefore, performing rot(T,2) after rot(T,1) only costs one more tile rotation.

In some examples, the smaller ciphertexts 508, 510, and 512 may be tiles. In various examples, as describe above, a method for computing rotations of v may require on average less than n tile rotations when simulated using the smaller ciphertexts 508, 510, and 512. In some examples, a rotation cache may also be used, such that when rotating the same vector 502 v by multiple offsets, a processor can re-use previously rotated tiles to further reduce the number of rotation operations. In various examples, the techniques may also be extended to an n-dimensional input tensor V, divided into n-dimensional tiles T as in a tile tensor. The rotation of tensor V along dimension i may be implemented by first rotating the array of tiles, then rotating the tiles according to an extension of the above rule. For example, the tiles may be rotated using a logical moving and rotation of smaller ciphertexts.

It is to be understood that the block diagram of FIG. 5 is not intended to indicate that the interleaved packing 500 is to include all of the components shown in FIG. 5. Rather, the interleaved packing 500 can include fewer or additional components not illustrated in FIG. 5 (e.g., additional vectors, or smaller ciphertexts, values, etc.).

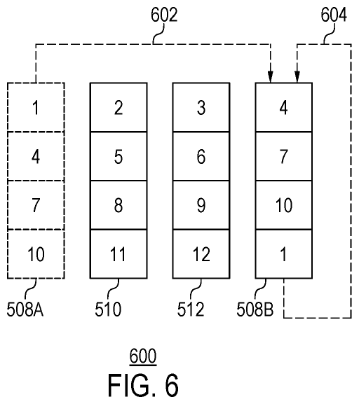

With reference now to FIG. 6, a block diagram shows an example simulated rotation of a vector using smaller ciphertexts. The example simulated rotation 600 of FIG. 6 includes smaller ciphertexts 508A, 510, 512, and 508B. For example, the ciphertext 508A may be the ciphertext 508 of FIG. 5. The simulated rotation 600 of FIG. 6 also includes a logical move operation indicated by a first arrow 602 and a rotation operation indicated by an arrow 604.

As shown in FIG. 5, a processor may perform both a logical move 602 and a rotation 604 such that original ciphertext 508A is both moved to the right of ciphertext 512 and rotated by one value, such that slot 0 is moved to slot 3 and the rest of the slots moved up in rank accordingly. In various examples, the logical move 602 may be moving the smaller ciphertext within a memory or logically moving the smaller ciphertext relative to the other smaller ciphertexts. The resulting sequence of values, as read row-by-row, may be [2,3,4,5,6,7,8,9,10,11,12,1], which is the same result a rotation performed on the larger vector [1,2,3,4,5,6,7,8,9,10,11,12]. However, in FIG. 5 a rotation of only a smaller ciphertext is performed instead of three rotations in the naive approach described above, thus resulting in a much more efficient operation.

It is to be understood that the block diagram of FIG. 6 is not intended to indicate that the simulated rotation 600 is to include all of the components shown in FIG. 6. Rather, the simulated rotation 600 can include fewer or additional components not illustrated in FIG. 6 (e.g., additional vectors, or smaller ciphertexts, values, operations, etc.).

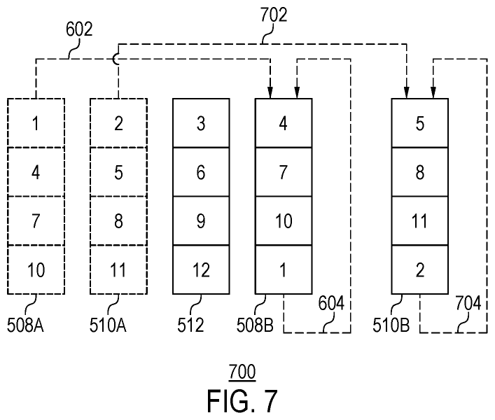

With reference now to FIG. 7, a block diagram shows an example simulated rotation of a vector with an offset of two using smaller ciphertexts. The example simulated rotation 700 of FIG. 7 includes similarly numbered elements from FIG. 6. In addition, the simulated rotation 700 includes an additional logical move 702 and rotation 704.

In the example of FIG. 7, a processor may perform a rotation by an offset of 2. In particular, the processor can perform the rotation 604 on ciphertext 508A to result in ciphertext 508B and a rotation 704 on ciphertext 510A to result in ciphertext 510B. The resulting sequence of values as read row by row across ciphertexts 512, 508B, 510B may be [3, 4, 5, 6, 7, 8, 9, 10, 11, 12, 1, 2], which is the same result of two rotations performed on the larger vector [1, 2, 3, 4, 5, 6, 7, 8, 9, 10, 11, 12]. However, in FIG. 5 two rotations of only a smaller ciphertext are performed, thus resulting in a more efficient rotation operation. In some examples, if a rotation of 1 was previously performed, then the processor can reuse one rotated tile and the efficiency may be further improved. For example, the rotated tile from the previously performed rotation 604 of FIG. 6 may have been stored in a rotation cache and subsequently used instead of performing the same rotation again. Thus, only rotation 704 may then be performed, resulting in further efficiency in such cases. The additional optional use of a rotation cache can therefore speed up operations if the processor is to rotate the same input by multiple offsets. Moreover, the logical moves 602 and 702 are negligible in terms of effects on performance.

It is to be understood that the block diagram of FIG. 7 is not intended to indicate that the simulated rotation 700 is to include all of the components shown in FIG. 7. Rather, the simulated rotation 700 can include fewer or additional components not illustrated in FIG. 7 (e.g., additional vectors, or smaller ciphertexts, values, etc.).

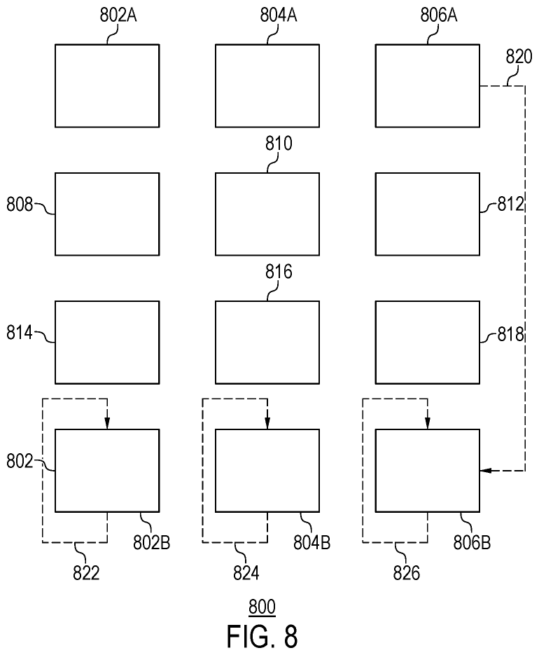

With reference now to FIG. 8, a block diagram shows an example simulated rotation of a multi-dimensional tensor using smaller tiles. The example simulated rotation 800 of FIG. 8 includes a set of tiles 802A, 804A 806A, 808, 810, 812, 814, 816, 818, 802B, 804B, and 806B. The simulated rotation 800 further includes a logical move 820 and a set of tile rotations 822, 824, and 826.

In various examples, a processor may rotate an n-dimensional tensor split into n-dimensional tiles. In the example of FIG. 8, the processor is rotating a two dimensional tensor split into two dimensional tiles. For example, a tensor may have been split into 9 tiles including tiles 802A, 804A 806A, 808, 810, 812, 814, 816, 818. The processor can then move 820 tiles 802A, 804A, and 806A to below tiles 814, 816, and 818 and rotate tiles 802A, 804A, and 806A to generate rotated tiles 802B, 804B, and 806B. For example, the tiles 802A, 804A, and 806A may be rotated using the logical move and rotation of smaller ciphertexts.

It is to be understood that the block diagram of FIG. 8 is not intended to indicate that the simulated rotation 800 is to include all of the components shown in FIG. 8. Rather, the simulated rotation 800 can include fewer or additional components not illustrated in FIG. 8 (e.g., additional tensors, or smaller tiles, operations, etc.).

The descriptions of the various embodiments of the present techniques have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system, comprising a processor to:
pack a received tensor using a designated packing to generate a plurality of smaller ciphertexts; and
compute a rotation using the plurality of smaller ciphertexts to simulate a rotation operation on the tensor.

2. The system of claim 1, wherein the processor is to store a smaller ciphertext rotation in a rotation cache and use the stored rotation from the rotation cache for an additional offset on the received tensor instead of executing an additional rotation.

3. The system of claim 1, wherein computing the rotation comprises moving a smaller ciphertext and rotating the moved ciphertext.

4. The system of claim 1, wherein the processor is to use the simulated rotation to simulate a rotation operation in an algorithm with a tile size constraint or a ciphertext size constraint to remove the tile size constraint or the ciphertext size constraint.

5. The system of claim 1, wherein the processor is to process rotations on the smaller ciphertexts in parallel.

6. A computer-implemented method, comprising:
packing, via a processor, a received tensor using a designated packing to generate a plurality of smaller ciphertexts; and
computing, via the processor, a rotation using the plurality of smaller ciphertexts to simulate a rotation operation on the tensor.

7. The computer-implemented method of claim 6, further comprising storing, via the processor, a smaller ciphertext rotation in a rotation cache and using the stored rotation from the rotation cache for an additional offset on the received tensor instead of executing an additional rotation.

8. The computer-implemented method of claim 6, wherein computing the rotation comprises moving a smaller ciphertext and rotating the moved ciphertext.

9. The computer-implemented method of claim 6, further comprising simulating, via the processor, the rotation operation in an algorithm with a tile size constraint or a ciphertext size constraint to remove the tile size constraint or ciphertext size constraint.

10. The computer-implemented method of claim 6, comprising processing, via the processor, rotations on the smaller ciphertexts in parallel.

11. A computer program product for simulating rotation operations, the computer program product comprising a computer-readable storage medium having program code embodied therewith, the program code executable by a processor to cause the processor to:
pack a received tensor using an interleaved packing to generate a plurality of smaller ciphertexts; and
compute a rotation using the plurality of smaller ciphertexts to simulate a rotation operation on the tensor.

12. The computer program product of claim 11, further comprising program code executable by the processor to store a smaller ciphertext rotation in a rotation cache and use the stored rotation from the rotation cache for an additional offset on the received tensor instead of executing an additional rotation.

13. The computer program product of claim 11, further comprising program code executable by the processor to move a smaller ciphertext relative to another smaller ciphertext and rotate the moved ciphertext.

14. The computer program product of claim 11, further comprising program code executable by the processor to simulate the rotation operation in an algorithm with a tile size constraint or a ciphertext size constraint to remove the tile size constraint or the ciphertext size constraint.

15. The computer program product of claim 11, further comprising program code executable by the processor to process rotations on the smaller ciphertexts in parallel.

16. A system, comprising a processor to:
pack a received multi-dimensional tensor using a designated packing to generate a plurality of smaller multi-dimensional tiles; and
compute a rotation using the plurality of smaller multi-dimensional tiles to simulate a rotation operation on the multi-dimensional tensor along a dimension.

17. The system of claim 16, wherein the processor is to store a smaller multi-dimensional tile rotation in a rotation cache and use the stored rotation from the rotation cache for an additional offset on the received multi-dimensional tensor instead of executing an additional rotation.

18. The system of claim 16, wherein the processor is to move a row of smaller multi-dimensional tiles relative to other rows of smaller multi-dimensional tiles, and rotate the moved row of smaller multi-dimensional tiles.

19. The system of claim 16, wherein the processor is to use the simulated rotation to convert an algorithm with a tile size constraint or a ciphertext size constraint into an algorithm without any tile size constraint or the ciphertext size constraint.

20. The system of claim 16, wherein the processor is to process rotations on the smaller multi-dimensional tiles in parallel.

21. A computer-implemented method, comprising:
packing, via a processor, a received multi-dimensional tensor using an designated packing to generate a plurality of smaller multi-dimensional tiles; and
computing, via the processor, a rotation using the plurality of smaller multi-dimensional tiles to simulate a rotation operation on the multi-dimensional tensor along a dimension.

22. The computer-implemented method of claim 21, comprising storing, via the processor, a smaller multi-dimensional tile rotation in a rotation cache and using the stored rotation from the rotation cache for an additional offset on the received multi-dimensional tensor instead of executing an additional rotation.

23. The computer-implemented method of claim 21, wherein computing the rotation comprises moving a row of smaller multi-dimensional tiles relative to other rows of smaller multi-dimensional tiles, and rotating the moved row of smaller multi-dimensional tiles.

24. The computer-implemented method of claim 21, comprising using the simulated rotation to convert an algorithm with a tile size constraint or a ciphertext size constraint into an algorithm without any tile size constraint or the ciphertext size constraint.

25. The computer-implemented method of claim 21, comprising processing, via the processor, rotations on the smaller multi-dimensional tiles in parallel.
